(19) United States
(12) Patent Application Publication
(10) Pub. No.: US 2015/0150260 A1
(43) Pub. Date: Jun. 4, 2015

(54) DIURON-CONTAINING THINNERS

(71) Applicant: LANXESS Distribution GmbH, Leverkusen (DE)

(72) Inventor: Frank Saalfeld, Kuerten-Duerscheid (DE)

(21) Appl. No.: 14/403,053

(22) PCT Filed: May 24, 2013
(86) PCT No.: PCT/EP2013/060778

§ 371 Date: Nov. 21, 2014

(30) Foreign Application Priority Data
May 25, 2012 (EP) 12169559.7

(51) Int. Cl. A01N 47/30

(52) U.S. Cl. CPC A01N 47/30

(57) ABSTRACT

The present invention relates to a thinning method, in particular for fruit thinning, using 3-(3,4 -dichlorophenyl)-1,1-dimethylurea (diuron), and to thinning compositions comprising diuron.

The present invention relates to a thinning method, in particular for fruit thinning, using 3-(3,4-dichlorophenyl)-1,1-dimethylurea (diuron) and to thinning compositions comprising diuron.

Thinning continues to be one of the most important practices in fruit production, where thinning is to be understood as meaning reducing the number of fertilized flowers and/or the number of fruits. Thinning is typically done either mechanically, either manually or using a machine, or else by means of chemicals.

Advantages which can be achieved by thinning are in particular the improvement of fruit size, fruit colour and/or fruit quality, which is associated with substantially improved profitability.

Other aspects which are observed are improved flowering in the year which follows good flowering, or breaking and preventing biennial bearing in endangered varieties and young stands, and avoiding the breaking of overcropping branches, severe exhaustion of the tree and the reduced cold tolerance of the tree which this entails.

In most growing regions, manual thinning is prohibitive for financial reasons. Machine-thinning can be employed to a limited extent only because it requires the trees to be trained in a specific shape and typically causes a high degree of collateral damage to the plant.

Chemical thinning is therefore advantageous.

However, known chemical thinning agents such as urea and ammonium thiosulphate, which are not approved for this purpose for example in Germany, lack a satisfactory reliability of action and are frequently poorly tolerated by plants at the concentrations employed, which are necessarily high. The activity and plant tolerance of other thinning agents, too, are not particularly suited to practice conditions since, as a function of the developmental stage of the fruit and the climatic conditions, a very highly pronounced variety-dependent lack of reliable activity has always been observed during and after the application.

All these known thinning agents act via the plant's hormone balance, such as, for example, via the plant hormones auxin and ethylene in apples. As a result, undesirable activities are frequently observed when these agents are employed, such as, for example, a reduced activity at low concentrations, excessive thinning under adverse conditions at the point in time of application, or in some cases even enhanced fruit crop load. The agents from the carbamate group which are employed in many countries additionally act as insecticides and can therefore be employed to a limited extent only.

The use of photosynthesis-inhibiting active substances for fruit thinning has already been described in J. Amer. Soc. Hort. Sci. 115(1): 14-19 (1990). The active substances mentioned in that specification have, however, not found commercial use as thinning agents since the plant tolerance is unsatisfactory, for example in the case of metribuzin.

EP 1427 286 A discloses the use of a thinning composition comprising the photosynthesis-inhibiting active substance metamitron.

Metamitron is known for its plant-injurious potential. To avoid foliar necroses, the application therefore has to be very precise in terms of timing and quantity.

It was therefore an object to provide an alternative thinning composition which is effective and simple to use.

It has now been found that thinning compositions comprising diuron are particularly suitable. The invention therefore comprises a thinning method which is characterized in that a composition comprising diuron is applied to plant organs. Furthermore, the invention comprises the use of compositions comprising diuron for thinning.

It should be noted here that the scope of the invention extends to any desired and possible combinations of the components, ranges of data and/or methodological parameters mentioned hereinabove and hereinbelow, either in general or in preferred ranges.

The thinning compositions can be employed for thinning blossom or fruit, with fruit thinning being preferred.

The method according to the invention is particularly suitable for thinning, in particular fruit thinning, in crops of stone fruit and pome fruit, with pome fruit crops being preferred. Preferred pome fruit crops are those of the following varieties: all varieties of apple such as, for example, Boskoop, Braeburn, Cox Orange, Elsuar, Gala, Gloster, Golden Delicious, Fuji, Kanzi, Jamba, James Grieve, Jonagold, Jonathan, Lobo, McIntosh, Red Delicious, Spartan, all varieties of pears such as, for example, Conference, Quince and Asian Pear.

Preferred stone fruit crops are crops of sweet cherry, morello cherry, peach, apricot and plum. Further preferred crops are olive, pistachio, kiwi fruit, grape vines or citrus fruit such as, for example tangerines.

If fruit are thinned, fruit thinning takes place for example in the 3- to 30-mm fruit stage, preferably in the 6- to 30-mm fruit stage, preferably in the 8- to 17-mm fruit stage, in particular in the case of pome fruit crops, the preferred crops being the same. In the case of sweet cherry and morello cherry, fruit thinning takes place for example in the 3- to 17-mm fruit stage.

The method according to the invention employs compositions, in particular ready-to-use thinning compositions comprising diuron, some of which are novel and in this case likewise subject-matter of the invention.

The compositions, hereinbelow synonymously also referred to as ready-to-use thinning compositions, preferably comprise
at least 70% by weight, preferably at least 80% by weight, especially preferably at least 90% by weight of water
0.001% by weight to 0.2% by weight, preferably 0.002% by weight to 0.1% by weight and especially preferably 0.002% to 0.2% by weight of diuron.

Besides diuron and water, the thinning compositions according to the invention optionally additionally comprise additives.

Furthermore, the compositions according to the invention also comprise, or in each case do not comprise, other thinning agents, growth regulators and other further agrochemical active substances.

The additives mentioned hereinbelow independently of one another may also not be present.

Additives which may be present are, for example,
hygroscopic substances and/or humectants for regulating moisture: hygroscopic substances are, for example, hygroscopic inorganic salts such as, for example, calcium chloride or calcium nitrate; magnesium chloride or magnesium nitrate. Examples of suitable humectants are organic substances such as, for example, glycerol, polydextrose, sorbitol, xylitol, propylene glycols, polyethylene glycols or mixtures of these polyols.
surface-active substances such as, for example, surfactants. Surfactants may be, for example, nonionic, cationic and amphoteric surfactants, preferably anionic surfactants. Examples of suitable anionic surfactants are alkyl sulphates, alkyl ether sulphates, alkylarylsulphonates, alkyl succinates, alkyl sulphosuccinates, N-alkylsarcosinates, acyl taurates, acyl isethionates, alkyl phosphates, alkyl ether phosphates, alkyl ether carboxylates, alpha-olefinsulphonates, in particular the alkali metal and alkaline earth metal salts, for example sodium, potassium, magnesium, calcium and ammonium and triethanolamine salts. The alkyl ether sulphates, alkyl ether phosphates and alkyl ether carboxylates may in each case have for example between 1 and 10 ethylene oxide or propylene oxide units, preferably 1 to 3 ethylene oxide units.
Examples which are suitable are sodium lauryl sulphate, ammonium lauryl sulphate, sodium lauryl ether sulphate, ammonium lauryl ether sulphate, sodium lauryl sarcosinate, sodium oleyl succinate, ammonium lauryl sulphosuccinate, sodium dodecylbenzenesulphonate, triethanolamine dodecylbenzenesulphonate.
wetters such as, for example, alkali metal, alkaline earth metal or ammonium salts of aromatic sulphonic acids, for example lignosulphonic acid, phenolsulphonic acid, naphthalene- and dibutylnaphthalenesulphonic acid, and of fatty acids, alkyl- and alkylarylsulphonates, alkyl sulphates, lauryl ether sulphates and fatty alcohol sulphates, and salts of sulphated hexa-, hepta- and octadecanols or fatty alcohol glycol ethers, condensates of sulphonated naphthalene and its derivatives with formaldehyde, condensates of naphthalene or of the naphthalenesulphonic acids with phenol and formaldehyde, polyoxyethylene octylphenol ether, ethoxylated isooctyl-, octyl- or nonylphenol, alkylphenol polyglycol ethers or tributylphenyl polyglycol ether, alkylaryl polyether alcohols, isotridecyl alcohol, fatty alcohol/ethylene oxide condensates, ethoxylated castor oil, polyoxyethylene alkyl ethers or polyoxypropylene, lauryl alcohol polyglycol ether acetate, sorbitol esters, lignin-sulphite waste liquors or methyl cellulose.
emulsifiers such as, for example, sodium, potassium and ammonium salts of straight-chain aliphatic carboxylic acids of chain length C₁₂-C₂₀, sodium hydroxyoctadecanesulphonate, sodium, potassium and ammonium salts of hydroxy-fatty acids of chain length C₁₂-C₂₀ and their sulphation or acetylation products, alkyl sulphates, also as the triethanolamine salts, alkyl(C₁₀-C₂₀)-sulphonates, alkyl(C₁₀-C₂₀)-arylsulphonates, dimethyldialkyl(C₈-C₁₈)-ammonium chloride, acyl-, alkyl-, oleyl- and alkylaryloxethylates and their sulphation products, alkali metal salts of the sulphosuccinic esters with aliphatic saturated monohydric alcohols of chain length C₄-C₁₆, sulphosuccinic acid 4-esters with polyethylene glycol ethers of monohydric aliphatic alcohols of chain length C₁₀-C₁₂ (disodium salt), sulphosuccinic acid 4-esters with polyethylene glycol nonylphenyl ether (disodium salt), sulphosuccinic acid bis-cyclohexyl ester (sodium salt), lignosulphonic acid and its calcium, magnesium, sodium and ammonium salts, polyoxyethylene sorbitan monooleate with 20 ethylene oxide groups, resin acids, hydrogenated and dehydrogenated resin acids and their alkali metal salts, dodecylated sodium diphenyl ether disulphonate, and copolymers of ethylene oxide and propylene oxide with a minimum content of 10% by weight of ethylene oxide. The following are preferably used as emulsifiers: sodium lauryl sulphate, sodium lauryl ether sulphate, ethoxylated (3 ethylene oxide groups); the polyethylene glycol-(4-20) ethers of oleyl alcohol, and the polyethylene oxide-(4-14) ethers of nonylphenol.
dispersants such as, for example, alkylphenol polyglycol ethers.
stabilizers such as, for example, cellulose and cellulose derivatives.
stickers such as carboxymethylcellulose, natural and synthetic polymers in the form of powders, granules or lattices, such as gum arabic, polyvinyl alcohol, polyvinyl acetate, and natural phospholipids such as cephalins and lecithins, and synthetic phospholipids and liquid paraffins.
spreaders such as, for example, isopropyl myristate, polyoxyethylene nonylphenyl ether and polyoxyethylene laurylphenyl ether.
organic solvents such as, for example, mono- or polyhydric alcohols, esters, ketones and hydrocarbons. Examples of suitable solvents are paraffins, for example mineral oil fractions, mineral and vegetable oils, butanol or glycol and their ethers and esters, ketones such as acetone, methyl ethyl ketone, methyl isobutyl ketone or cyclohexanone.
fragrances and colorants, such as inorganic pigments, for example iron oxide, titanium oxide, Prussian blue, and organic dyes such as alizarin, azo and metal phthalocyanine dyes and trace nutrients such as salts of iron, manganese, boron, copper, cobalt, molybdenum and zinc.
buffers, buffer systems or pH regulators.
crystallization inhibitors such as N-alkyl-pyrrolidones, such as, for example, N-octyl-pyrrolidone and N-dodecylpyrrolidone, furthermore copolymers of polyvinylpyrrolidone and polyvinyl alcohol, such as, for example, the polyvinylpyrrolidone/polyvinyl alcohol copolymer known by the name Luviskol VA 64 ® (BASF), furthermore dimethyl alkylcarboxamides, such as dimethyl decanamide, or the dimethyl C₆₋₁₂-alkanecarboxamide mixture known by the name Hallcomid® (Hall Comp.), and furthermore copolymers of ethylenediamine with ethylene oxide and propylene oxide, such as, for example, the product known by the name Synperonic® T 304 (Uniqema).

Other thinning agents may be selected for example from the group consisting of:

metamitron, carbaryl, 2-(1-naphthyl)acetic acid (NAA), benzyladenine, naphthyloxyacetic acid (NES), gibberelic acid, paclobutrazole, ammonium thiosulphate and urea, and ethylene formers such as ethephon, in particular in the case of apple varieties which are difficult to thin and/or display slight biennial bearing, such as Elstar or Red Delicious.

An example of a growth regulator which can be employed is prohexadione-calcium.

Examples of further agrochemical active substances which the thinning compositions may comprise are fungicides and insecticides.

Fungicides may, for example, be selected from the group consisting of: sulphur (wettable sulphur), copper preparations, benzimidazole, bitertanol, dichlofluanid, fenamidone, fenarimol, fenhexamid, fludioxonil, fluopyram, fosetyl-aluminium, iprodione, myclobutanil, penconazole, triadimenol, vinclozolin, tolylfluanid (Euparen M®), captan, propineb, tebuconazol trifloxystrobin, kresoxim-methyl, dithianon, cyprodinil, pyrimethanil, mancozeb (Dithane Ultra®) and metiram.

Insecticides may, for example, be selected from the group consisting of: dimethoate, oxydemeton-methyl, malathion, parathion-methyl, phosphamidon, permethrin, amitraz, clofentezin, cyhalothrin, beta-cyfluthrin, fenproximate, diflubenzuron, methoxyfenozide, tebufenozide, imidacloprid, thiacloprid, thiamethoxam, spirodiclofen, clofentezine, fenoxycarb, parathion-methyl, XenTari®, tebufenozide, diflubenzuron, pirimicarb, tebufenpyrad, fenpyroximate, rapeseed oil, mineral oil and lecithin, with particular emphasis on imidacloprid and thiacloprid.

The compositions employed in accordance with the invention and the compositions according to the invention preferably furthermore include
calcium salts and preferably additionally
formate.

The calcium and the formates can be introduced into the compositions in the form of any compounds. Preferred for introducing formates are alkali metal formates such as, for example, potassium formate and sodium formate, alkali metal diformates such as, for example, potassium diformate and sodium diformate, and alkaline earth metal formates such as, for example, calcium formate, or mixtures of such formates. Preferred for introducing calcium are calcium formate and other calcium salts of organic carboxylic acids, calcium chloride, calcium nitrate and other inorganic calcium salts, with calcium formate and calcium chloride being preferred and calcium formate being especially preferred.

In one embodiment, the weight ratio of diuron, calcium calculated as calcium oxide and formate calculated as formic acid is 1:(0.1 to 500):(0.16 to 900), preferably 1:(0.5 to 100):(0.8 to 180).

Calcium formate is especially preferably employed because it avoids problems which may occur, as the case may be, with other calcium salts conventionally used in agrochemical formulations. Thus, for example, calcium formate is not hygroscopic or contaminated with alkaline contaminants (Ca(OH)₂) such as commercially available CaCl₂, and not as sparingly soluble in water as calcium carbonate.

Calcium-formate-comprising formulations furthermore have better rain fastness than the usually employed calcium salts (nitrate, carbonate and chloride).

A side-effect of calcium salts which is observed is that the compositions according to the invention, when applied to young plant organs (leaves and fruits), are well suited to avoid calcium deficiency symptoms in the plants and especially the fruits, such as, for example, bitter pit in apples.

Surprisingly, calcium formate in particular makes possible good formulation properties of the compositions to be employed in accordance with the invention and the compositions according to the invention.

The ready-to-use thinning compositions are preferably obtained from composition concentrations, for example by mixing with water, so as to simplify preparation, storage and transport.

Composition concentrates can be formulated as desired. Suitable formulations are, for example, capsule suspensions (CS), water-soluble concentrates (SL), suspension concentrates (SC), wettable powders (WP), water-dispersible granules (WG), with water-soluble concentrates (SL), suspension concentrates (SC) and water-dispersible granules (WG) generally being preferred. In principle, preferred formulation types will essentially depend on the components employed and their physical properties. Since these are known, however, it is customary practice to the skilled worker to determine a preferred formulation type in few experiments.

Composition concentrates may comprise for example
more than 0.2% by weight to 30% by weight, preferably 0.5% by weight to 30% by weight and especially preferably 2 to 20% by weight of diuron.

Composition concentrates according to the invention furthermore optionally comprise
0.2% by weight to 30% by weight, preferably 2% by weight to 30% by weight of calcium salts calculated for calcium oxide,
   and optionally furthermore
0.2% by weight to 30% by weight, preferably 2% by weight to 30% by weight, of formates, calculated for formic acid.

As regards the further components of the composition concentrates in addition to diuron, such as additives, other thinning agents, growth regulators and other further agrochemical active substances, what has been said hereinabove for the ready-to-use thinning compositions applies analogously here.

The ready-to-use compositions are applied by customary methods, that is to say for example by spraying, pouring, atomizing, injecting or painting on. The application is preferably carried out directly to the plant organs, in particular to leaves and/or fruits.

To carry out the method according to the invention, for example such an amount of ready-to-use compositions is applied that 0.005 to 2 kg/ha, preferably 0.01 to 1 kg/ha, especially preferably 0.01 to 0.5 kg/ha of diuron are preferably applied per application.

The number of applications may be, for example, one to six, preferably one, two or three. The advantage of the invention is that an efficient thinning composition is provided which can be applied without substantial other plant injuries.

### EXAMPLES

In an experimental field which was planted with apple trees cv. Braeburn Mariri Red M9 (planting distances 3.5×1.0 m) from a planting in spring 2006, in each case four plots of 5 trees each were sprayed with defined amounts of the compositions defined hereinbelow on 21 May 2012 when the blossom had a fruit size of 10 mm and on 30 May 2012 when the last blossoms had a size of 10 mm. Among those 5 trees, in each case 3 labelled branches of 3 trees with a uniform amount of blossom were evaluated according to the criteria specified in the following Table 1 and the 3 trees in toto according to the criteria specified in Table 2. The treatment was performed with an application rate of the ready-to-use compositions of 500 l/water per hectare and metre of crown height, which in this context corresponded to 1000 l per hectare.
Control experiment (1): no thinning
Hand (9): thinning was performed exclusively manually
Experiments 1 to 3: thinning was performed with the above-stated amounts of ready-to-use compositions which were obtained by mixing the amounts stated hereinbelow of a suspension concentrate comprising 808 g/l diuron, 50 g/l ethanediol. 34 g/l surfactants and further formulation adjuvants and 380 g/l water:
Experiment 1 (X0): 7 500 g of the suspension concentrate per 10 l of water (approx. 600 ppm)
Experiment 2 (X1): 3 750 g of the suspension concentrate per 10 l of water (approx. 300 ppm)
Experiment 3 (X2): 1 875 g of the suspension concentrate per 10 l of water (approx. 150 ppm)

TABLE 1
Evaluation of in each case three labelled branches
an three trees per plot

| | | | | Fruit | |
|---|---|---|---|---|---|
| | | | | after | |
| | | Blossom | Fruit before | June | Fruit per |
| | | cluster | June drop | drop | 100 |
| Treatment | | [n] | [n] | [n] | inflorescences |
| | 1/1 | 14.0 | 11.9 | 6.7 | 47.6 |
| | 1/2 | 16.3 | 18.6 | 12.2 | 74.8 |
| | 1/3 | 12.3 | 9.2 | 7.9 | 64.0 |
| | 1/4 | 16.9 | 12.7 | 11.2 | 66.4 |
| Control | 1 | 14.9 | 13.1 | 9.5 | 63.8 |
| | 9/1 | 16.4 | 21.0 | 13.8 | 83.8 |
| | 9/2 | 17.3 | 17.1 | 10.7 | 61.5 |
| | 9/3 | 19.0 | 16.7 | 12.0 | 63.2 |
| | 9/4 | 16.9 | 14.6 | 11.3 | 67.1 |
| By hand | 9 | 17.4 | 17.3 | 11.9 | 68.6 |
| | X0/1 | 9.4 | 6.6 | 0.5 | 5.3 |
| | X0/2 | 10.0 | 5.6 | 0.6 | 5.6 |
| | X0/3 | 10.0 | 7.2 | 0.7 | 7.0 |
| | X0/4 | 14.2 | 13.2 | 1.2 | 8.2 |
| Experiment 1 | X0 | 10.9 | 8.1 | 0.7 | 6.7 |
| | X1/1 | 13 | 6.9 | 1.4 | 11.1 |
| | X1/2 | 14.4 | 10.0 | 1.4 | 10.0 |
| | X1/3 | 15.8 | 6.0 | 1.2 | 7.7 |
| | X1/4 | 11.9 | 9.4 | 1.2 | 10.3 |
| Experiment 2 | X1 | 13.8 | 8.1 | 1.3 | 9.7 |
| | X2/1 | 13.2 | 11.4 | 2.7 | 20.2 |
| | X2/2 | 15.2 | 10.5 | 4.2 | 27.5 |
| | X2/3 | 12.8 | 12.6 | 4.9 | 38.3 |
| | X2/4 | 16.6 | 11.0 | 3.6 | 21.5 |
| Experiment 3 | X2 | 14.4 | 11.4 | 3.8 | 26.5 |

TABLE 2
Evaluation of the 3 labelled trees per plot

| | | Fruit/tree | Yield/tree | Fruit size | Fruit weight |
|---|---|---|---|---|---|
| Treatment | | [m] | [kg] | [mm] | (g) |
| | 1/1 | 143.0 | 21.51 | 70.37 | 150.44 |
| | 1/2 | 165.3 | 27.29 | 72.87 | 165.08 |
| | 1/3 | 115.6 | 16.64 | 70.3 | 144.72 |
| | 1/4 | 140.3 | 20.99 | 70.65 | 149.58 |
| Control | 1 | 140.9 | 21.61 | 71.05 | 152.46 |
| | 9/1 | 124.3 | 20.41 | 73.08 | 164.18 |
| | 9/2 | 136.7 | 21.99 | 72.73 | 160.90 |
| | 9/3 | 109.0 | 18.45 | 73.19 | 169.24 |
| | 9/4 | 105.7 | 19.67 | 76.15 | 186.12 |
| By band | 9 | 118.9 | 20.13 | 73.79 | 170.11 |
| | X0/1 | 4.7 | 0.88 | 80.82 | 214.88 |
| | X0/2 | 3.3 | 0.90 | 82.49 | 229.13 |
| | X0/3 | 10.3 | 2.80 | 82.62 | 271.06 |
| | X0/4 | 16.3 | 4.23 | 81.23 | 259.22 |
| Experiment 1 | X0 | 8.7 | 2.20 | 81.79 | 243.57 |
| | X1/1 | 7.3 | 1.40 | 78.18 | 231.25 |
| | X1/2 | 19.7 | 5.07 | 83.62 | 257.60 |
| | X1/3 | 23.0 | 5.67 | 81.87 | 246.39 |
| | X1/4 | 8.0 | 2.03 | 83.48 | 263.70 |
| Experiment 2 | X1 | 14.5 | 3.54 | 81.79 | 249.74 |
| | X2/1 | 41.0 | 8.63 | 78.57 | 210.56 |
| | X2/2 | 36.3 | 8.40 | 81.04 | 231.21 |
| | X2/3 | 49.7 | 11.50 | 80.40 | 231.53 |
| | X2/4 | 31.0 | 8.27 | 82.14 | 266.68 |
| Experiment 3 | X2 | 39.5 | 9.20 | 80.54 | 234.99 |

1. Use of diuron for thinning, preferably for fruit thinning.

2. Thinning method which is characterized in that a composition comprising diuron is applied to plant organs.

3. Method according to claim 2, characterized in that the thinning is fruit thinning.

4. Method according to claim 2 or 3, characterized in that the thinning takes place in pome fruit crops.

5. Method according to claim 2, characterized in that the thinning takes place in varieties of apple such as, for example, Boskoop, Braeburn, Cox Orange, Elstar, Gala, Gloster, Golden Delicious, Fuji, Kanzi, Jamba, James Grieve, Jonagold, Jonathan, Lobo, McIntosh, Red Delicious, Spartan, or varieties of pear such as, for example, Conference, Quince and Asian Pear.

6. Method according to claim 3, characterized in that the fruit thinning takes place in the 6- to 30-mm fruit stage, preferably in the 8- to 17-mm fruit stage.

7. Method according to claim 2, characterized in that the composition employed is a composition which comprises:
at least 70% by weight, preferably at least 80% by weight, especially preferably at least 90% by weight of water
0.001% by weight to 0.2% by weight, preferably 0.002% by weight to 0.1% by weight and especially preferably 0.002 to 0.2% by weight of diuron.

8. Method according to claim 7, characterized in that the composition furthermore additionally comprises additives.

9. Method according to claim 7, characterized in that the composition furthermore also comprises, or in each case does not comprise, other thinning agents, growth regulators and other further agrochemical active substances.

10. Method according to claim 7, characterized in that the composition furthermore comprises:
calcium salts and preferably additionally
formate.

11. Method according to claim 10, characterized in that it comprises calcium formate and that the weight ratio of diuron, calcium calculated as calcium oxide and formate calculated as formic acid is preferably 1:(0.1 to 500):(0.16 to 900), by preference 1:(0.5 to 100):(0.8 to 180).

12. Method according to claim 2, characterized in that such an amount of composition comprising diuron is applied that 0.005 to 2 kg/ha, preferably 0.01 to 1 kg/ha, especially preferably 0.01 to 0.5 kg/ha of diuron are preferably applied per application.

13. Method according to claim 2, characterized in that the method is carried out such that the compositions comprising diuron are applied in one to six, preferably in one, two or three, applications.

14. Composition comprising
at least 70% by weight, preferably at least 80% by weight, especially preferably at least 90% by weight of water
0.001% by weight to 0.2% by weight, preferably 0.002% by weight to 0.1% by weight and especially preferably 0.002 to 0.2% by weight of diuron
calcium salts and preferably additionally
formate.

15. Composition concentrate comprising
more than 0.2% by weight to 30% by weight, preferably 0.5% by weight to 30% by weight and especially preferably 2 to 20% by weight of diuron.
0.2% by weight to 30% by weight, preferably 2% by weight to 30% by weight of calcium salts calculated for calcium oxide
and optionally furthermore
0.2% by weight to 30% by weight, preferably 2% by weight to 30% by weight of formates calculated for formic acid.

16. Composition according to claim 14 or composition concentrate according to claim 15, characterized in that it additionally comprises, or in each case does not comprise, furthermore other thinning agents, growth regulators and other further agrochemical active substances.
